(19) United States
(12) Patent Application Publication
(10) Pub. No.: US 2013/0155202 A1
(43) Pub. Date: Jun. 20, 2013

(54) IMAGING APPARATUS

(71) Applicant: PANASONIC CORPORATION, Osaka (JP)

(72) Inventors: MOTONORI OGURA, Osaka (JP); TAKANORI YABUKI, Osaka (JP); KEISUKE OKAWA, Osaka (JP)

(73) Assignee: PANASONIC CORPORATION, Osaka (JP)

(21) Appl. No.: 13/713,094

(22) Filed: Dec. 13, 2012

(30) Foreign Application Priority Data
Dec. 14, 2011 (JP) 2011-273152

(51) Int. Cl. H04N 13/02

(52) U.S. Cl. CPC H04N 13/02
USPC 348/49

(57) ABSTRACT

An imaging apparatus of includes an imaging sensor that captures a subject image formed by an attached 3D conversion lens and generates an image data, a display device that displays an image based on the generated image data, a lens adjusting unit that adjusts a lens position of an optical system included in the attached 3D conversion lens, a controller that: (i) determines that a predetermined portion of the subject image which is to be moved according to the adjustment of the lens position, is at least one of (a) within a predetermined range in the image and (b) not within the predetermined range in the image, and (ii) causes the display device to display the determined result.

### BACKGROUND

1. Technical Field

The present disclosure relates to an imaging apparatus capable of capturing three-dimensional images.

2. Related Art

JP-A-2010-204482 discloses an imaging apparatus that is provided with a twin-lens optical system having a left-eye lens and a right-eye lens and is capable of capturing three-dimensional (3D) images. JP-A-2010-204482 discloses a technique relating to adjustment of a position of the twin-lens optical system.

### SUMMARY

In the technique disclosed in JP-A-2010-204482, an operator with expertise views a captured image of a chart and determines whether the adjustment of a position of the twin-lens optical system is appropriate. However, it is not easy for average users to view a captured image of a chart and determine whether adjustment of the position of the twin-lens optical system is necessary. Particularly in the imaging apparatus that is enabled to image three-dimensional (3D) images by attaching 3D conversion lens, adjustment of the position of the twin-lens optical system is desired for every attachment of the 3D conversion lens, and thus this problem becomes increasingly noticeable.

The present disclosure provides an imaging apparatus in which a user can easily determine whether adjustment of an optical system of a 3D conversion lens is appropriate.

An imaging apparatus of the present disclosure can be attached to a 3D conversion lens. The imaging apparatus includes, an imaging sensor that captures a subject image formed by the attached 3D conversion lens and generates an image data, a display device that displays an image based on the generated image data, a lens adjusting unit that adjusts a lens position of an optical system included in the attached 3D conversion lens, a controller that: (i) determines that a predetermined portion of the subject image which is to be moved according to the adjustment of the lens position, is at least one of (a) within a predetermined range in the image and (b) not within the predetermined range in the image, and (ii) causes the display device to display the determined result.

The present disclosure provides an imaging apparatus that can cause a user to easily determine whether adjustment of an optical system of a 3D conversion lens is appropriate.

### BRIEF DESCRIPTION OF DRAWINGS

FIG. 1 is a perspective view illustrating a state in which a 3D conversion lens is attached to a digital video camera.

FIG. 2 is a perspective view illustrating a state in which the 3D conversion lens is detached from the digital video camera 100.

FIG. 3 is a schematic diagram illustrating a configuration of the 3D conversion lens and an optical system of the digital video camera.

FIG. 4 is a schematic diagram for describing configuration of optical systems of the 3D conversion lens and the digital video camera.

FIG. 5 is a top view in which an adjustment mechanism housing unit in an opened state is viewed from the top.

FIGS. 6A and 6B are perspective views illustrating a state that a lens cap is viewed from the inside, and a perspective view illustrating a state that the lens cap is viewed from the outside.

FIG. 7 is a schematic diagram illustrating a configuration of the lens cap viewed from a surface opposed to a lens cap attaching portion when the lens cap is attached to the lens cap attaching portion.

FIG. 8 is a block diagram illustrating a configuration of the digital video camera.

FIG. 9A is a flowchart illustrating a case where the digital video camera detects attachment of the 3D conversion lens (1 of 2).

FIG. 9B is a flowchart illustrating a case where the digital video camera detects attachment of the 3D conversion lens (2 of 2).

FIG. 10 is a schematic diagram for describing a display content of a liquid crystal display monitor at an initial setting time.

FIG. 11 is a schematic diagram for describing a display content of the liquid crystal display monitor at a time when an inquiry is made if the 3D conversion lens is adjusted in a horizontal direction.

FIGS. 12A and 12B are schematic diagrams for describing a display content of the liquid crystal display monitor at a time when an adjustment in a horizontal direction is made on the 3D conversion lens 500.

FIGS. 13A and 13B are schematic diagrams for describing a display content of the liquid crystal display monitor at a time when a first adjustment in a vertical direction is made on the 3D conversion lens.

FIG. 14 is a schematic diagram for describing a display content of the liquid crystal display monitor at a time when a preparation on a second adjustment in a vertical direction is made on the 3D conversion lens.

FIGS. 15A and 15B are schematic diagrams for describing a display content of the liquid crystal display monitor at the time when the second adjustment in a vertical direction is made on the 3D conversion lens.

### DETAILED DESCRIPTION OF PREFERRED EMBODIMENT

Embodiments will be described below in detail appropriately with reference to the accompanying drawings. However, an excessively detailed description may be omitted. For example, detailed descriptions of already well-known items and redundant descriptions for substantially the same configurations may be omitted to avoid the following descriptions from being unnecessarily redundant and to facilitate understanding by persons skilled in the art.

The present inventor provides the accompanying drawings and the following descriptions to cause persons skilled in the art to sufficiently understand the disclosure and does not intend to limit the subject matter described in the scope of claims by the drawings and the descriptions.

A description will now be given of a reason why a user who views an image for which a camera shake is corrected has uncomfortable feelings when the correction technique described in JP-A-2002-94877 is applied to the imaging apparatus using the imaging sensor using a manner of reading lines sequentially.

### 1. First Embodiment

A first embodiment will be described with reference to the drawings.

1-1. Outline

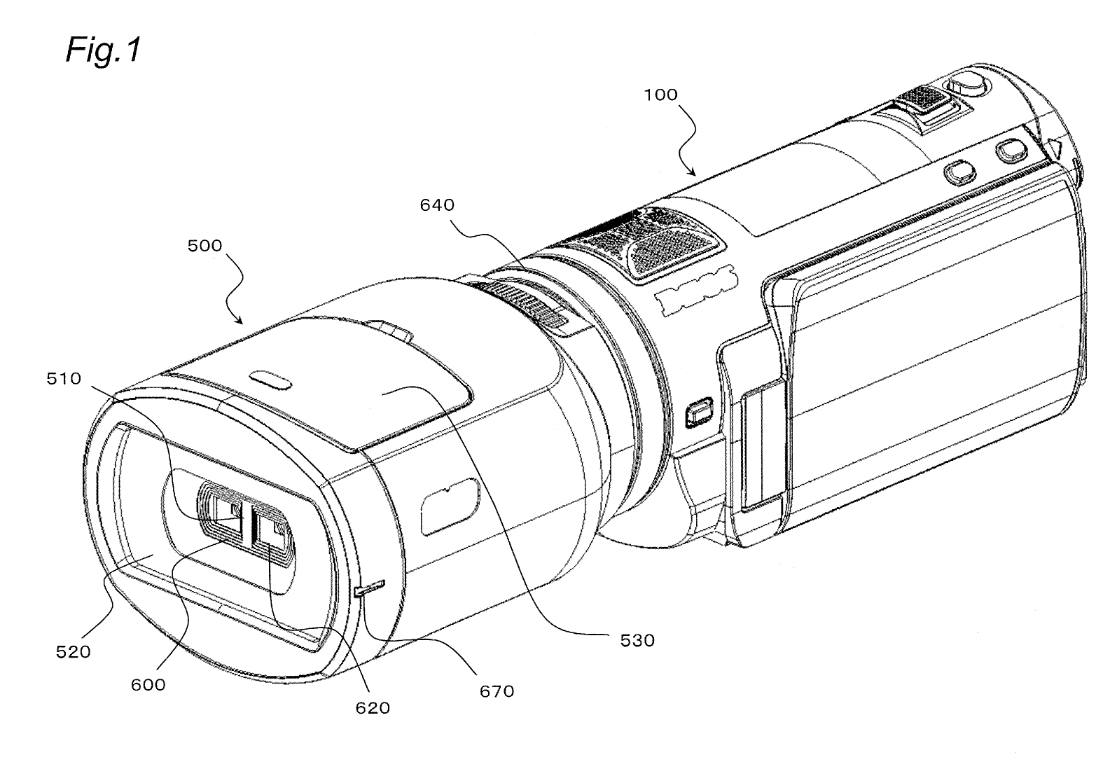

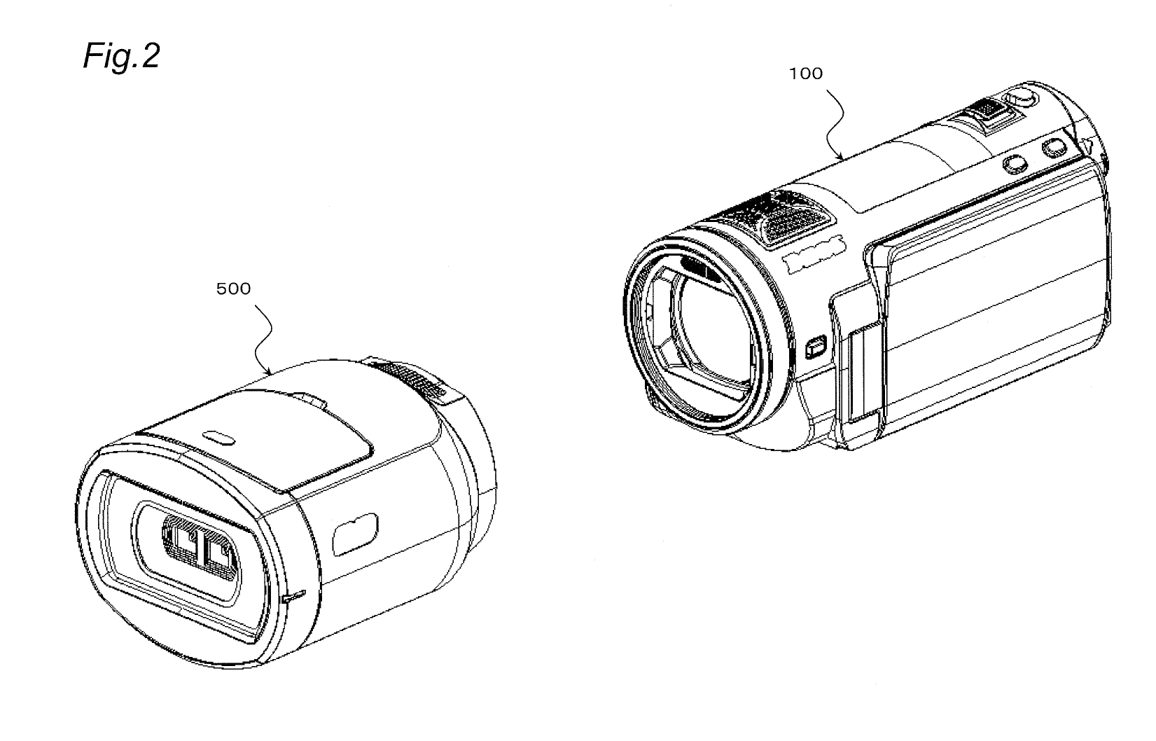

An outline of a digital video camera 100 according to the first embodiment will be described with reference to FIGS. 1 to 3. FIG. 1 is a perspective view illustrating a state that a 3D conversion lens 500 is attached to the digital video camera 100. FIG. 2 is a perspective view illustrating a state that the 3D conversion lens 500 is detached from the digital video camera 100.

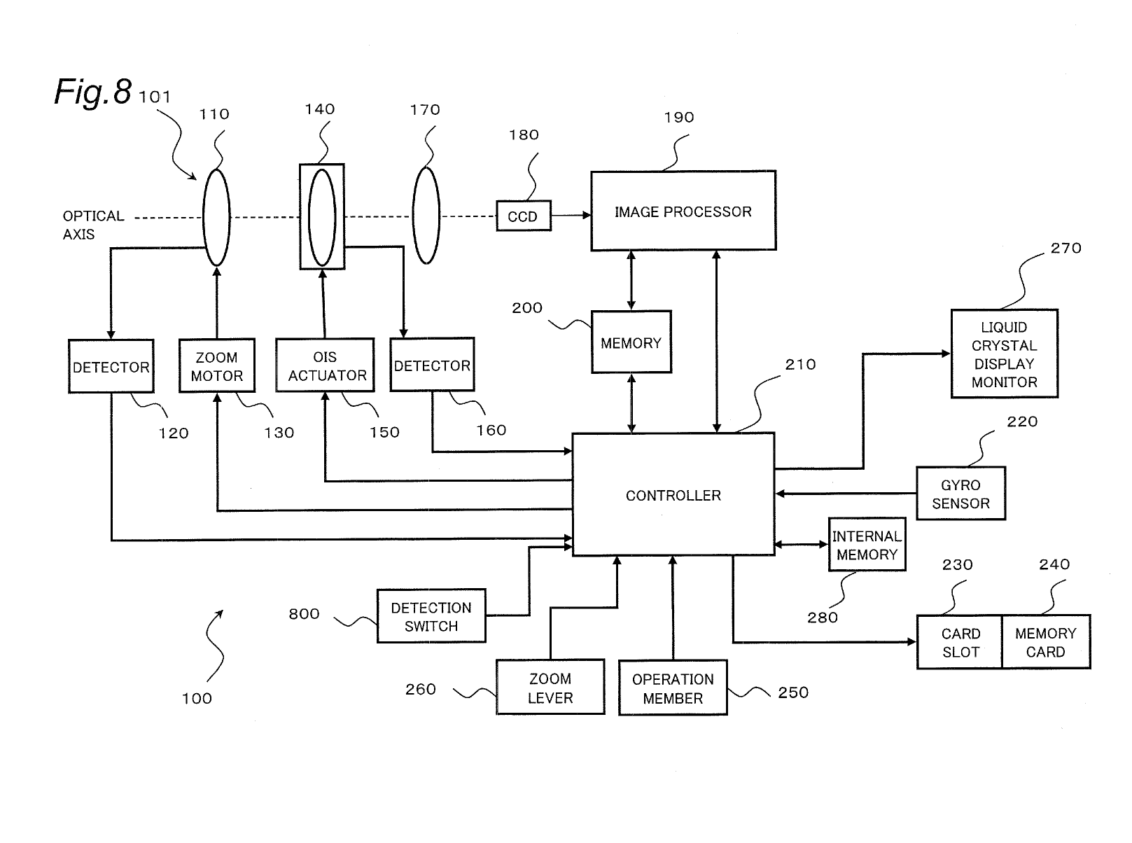

As shown in FIG. 1, the digital video camera 100 has an attaching portion 640 for attaching the 3D conversion lens 500. The attaching portion 640 has an internal thread inside. On the other hand, the 3D conversion lens 500 has an external thread to be engaged with the internal thread of the attaching portion 640. A user makes the external thread of the 3D conversion lens 500 with the internal thread of the attaching portion 640 to be capable of attaching the 3D conversion lens 500 to the digital video camera 100. The digital video camera 100 can magnetically detect that the 3D conversion lens 500 is attached with a detection switch 800 (see FIG. 8, described later).

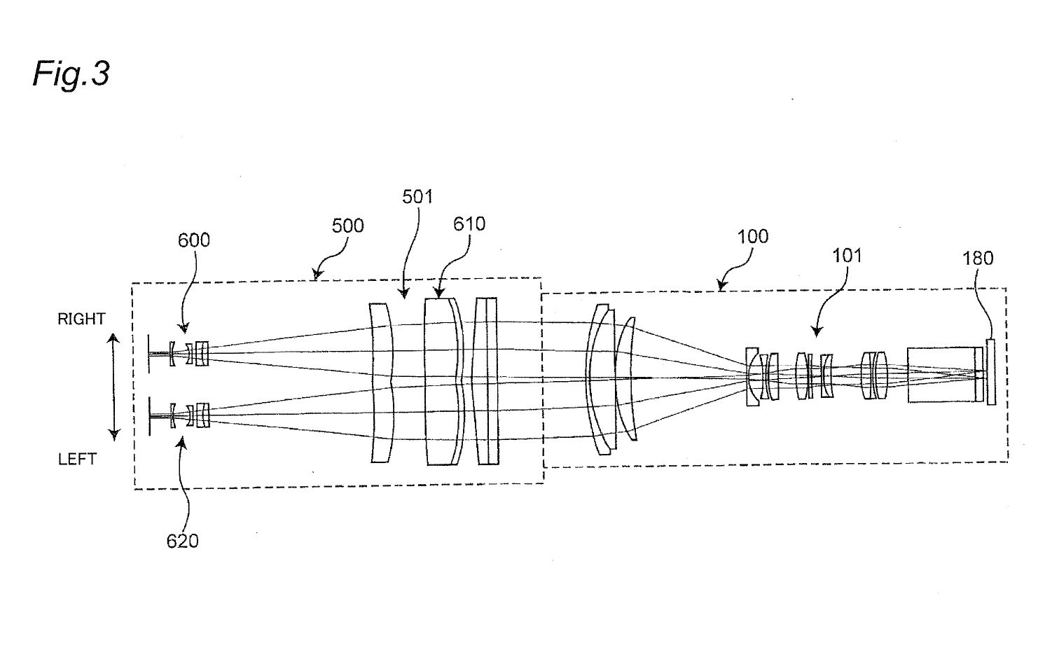

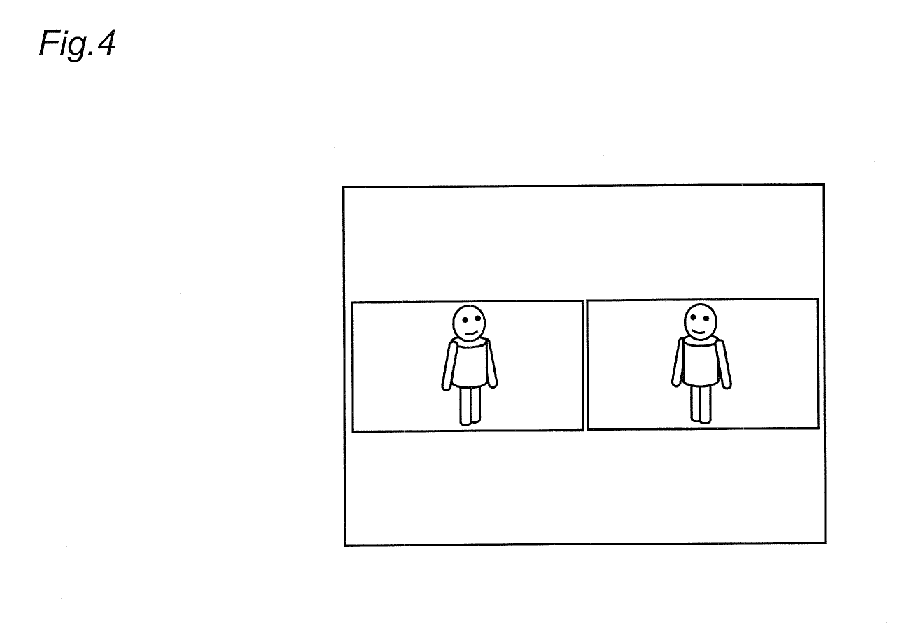

FIG. 3 is a diagram describing configurations of an optical system 501 of the 3D conversion lens 500 and an optical system 101 of the digital video camera 100. The optical system 501 of the 3D conversion lens 500 has a right-eye lens 600 for introducing light for forming a subject image for a right-eye (right eye subject image) in a 3D (three dimensions) image, a left-eye lens 620 for introducing light for forming a subject image for a left-eye (left eye subject image), and a common lens 610 that is configured so that a left-eye lens and a right eye lens are integrated, and guides the lights introduced into the right-eye lens 600 and the left-eye lens 620 in the optical system 101 of the digital video camera 100. The lights incident on the right-eye lens 600 and the left-eye lens 620 of the 3D conversion lens 500 are introduced into the optical system 101 of the digital video camera 100 via the common lens 610, and are imaged as an image of a side-by-side format on a CCD image sensor 180 of the digital video camera 100 (see FIG. 8, described later), for example, as shown in FIG. 4. The right-eye lens 600 and the left-eye lens 620 are configured to be movable up, down, right and left in the 3D conversion lens 500 (a direction vertical to an optical axis).

Returning to FIG. 1, the 3D conversion lens 500 has the adjustment mechanism housing unit 530. Adjustment dials, such as a horizontal adjustment dial, a first vertical adjustment dial and a second vertical adjustment dial, described later, are housed in the adjustment mechanism housing unit 530. A driving system which move the right-eye lens 600 and the left-eye lens 620 according to movements of the adjustment dials is housed in the adjustment mechanism housing unit 530

The user can adjust positions of the right-eye lens 600 and the left-eye lens 620 in the 3D conversion lens 500 by operating the various adjustment dials. When the positions of the right-eye lens 600 and the left-eye lens 620 in the 3D conversion lens 500 are adjusted respectively, the light incident on the 3D conversion lens 500 is imaged on a position on the CCD image sensor 180 of the digital video camera 100 according to the adjustment amount.

The digital video camera 100 according to the first embodiment has a function for making adjustment easy after the 3D conversion lens 500 is attached.

1-2. Adjustment Dials

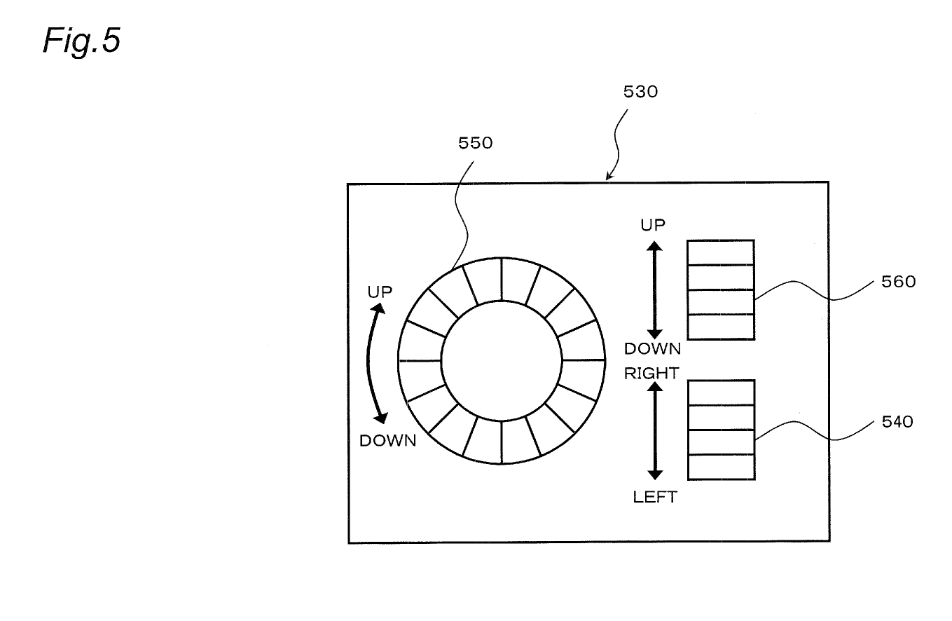

The various adjustment dials housed in the adjustment mechanism housing unit 530 will be described with reference to FIG. 5. FIG. 5 is a top view in which the adjustment mechanism housing unit 530 in an opened state is viewed from the top. The horizontal adjustment dial 540 (both lens horizontal adjustment dial), the first vertical adjustment dial 550 (both lens vertical adjustment dial), and the second vertical adjustment dial 560 (one lens vertical adjustment dial) are housed in the adjustment mechanism housing unit 530. The horizontal adjustment dial 540 is a dial for adjusting positions of the right-eye lens 600 and the left-eye lens 620 in a horizontal direction. The first vertical adjustment dial 550 is a dial for adjusting positions of the right-eye lens 600 and the left-eye lens 620 in a vertical direction. The second vertical adjustment dial 560 is a dial for adjusting a position of the left-eye lens 620 in the vertical direction. The horizontal adjustment dial 540, the first vertical adjustment dial 550 and the second vertical adjustment dial 560 have a gear shape. The horizontal adjustment dial 540 and the second vertical adjustment dial 560 are retained by a shaft, not shown, provided in a direction vertical to an arrow direction to be turnable in the arrow direction. The user can turn the horizontal adjustment dial 540 and the second vertical adjustment dial 560 to the arrow direction. Further, the first vertical adjustment dial 550 is retained by a shaft provided in a normal direction of a surface of the adjustment mechanism housing unit 530 to be turnable to an arrow direction (namely, a circumferential direction). The user can turn the first vertical adjustment dial 550 to the arrow direction.

When the user operates the horizontal adjustment dial 540, the right-eye lens 600 and the left-eye lens 620 move to the horizontal direction in the 3D conversion lens 500. When the user operates the first vertical adjustment dial 550, the right-eye lens 600 and the left-eye lens 620 move to the vertical direction in the 3D conversion lens 500. When the user operates the second vertical adjustment dial 560, the left-eye lens 620 moves to the vertical direction in the 3D conversion lens 500.

In such a configuration, the user can adjust the imaging positions of the lights incident via the right-eye lens 600 and the left-eye lens 620 on the CCD image sensor 180 by operating the horizontal adjustment dial 540, the first vertical adjustment dial 550 and the second vertical adjustment dial 560.

1-3. Configuration of the Lens Cap

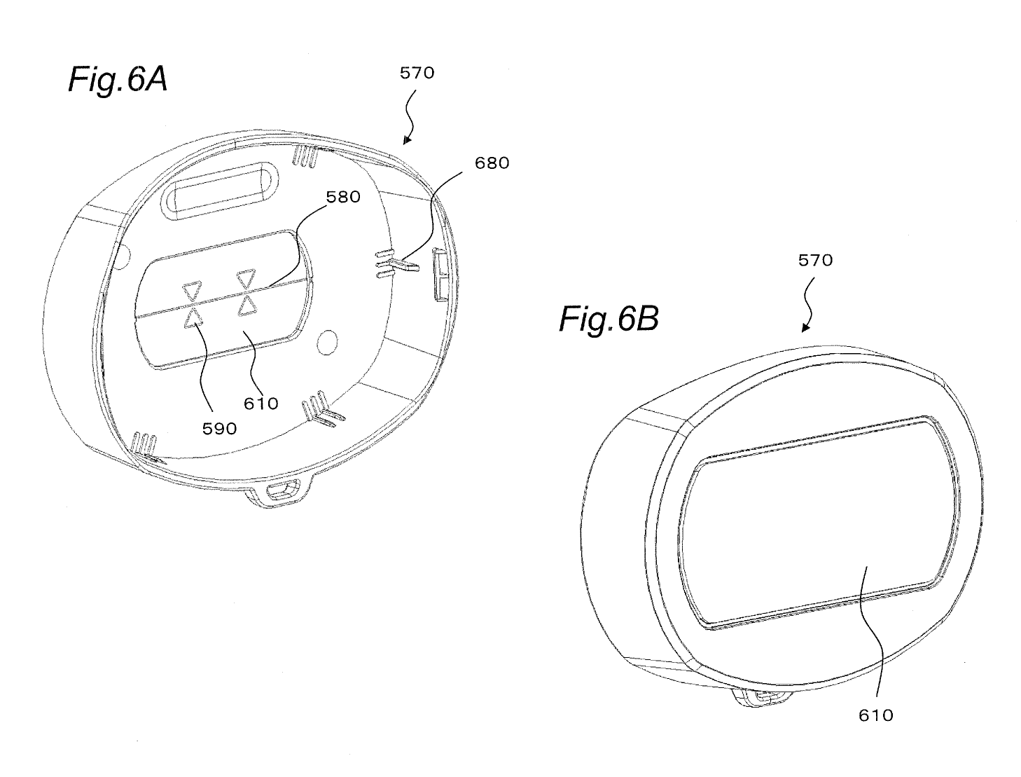

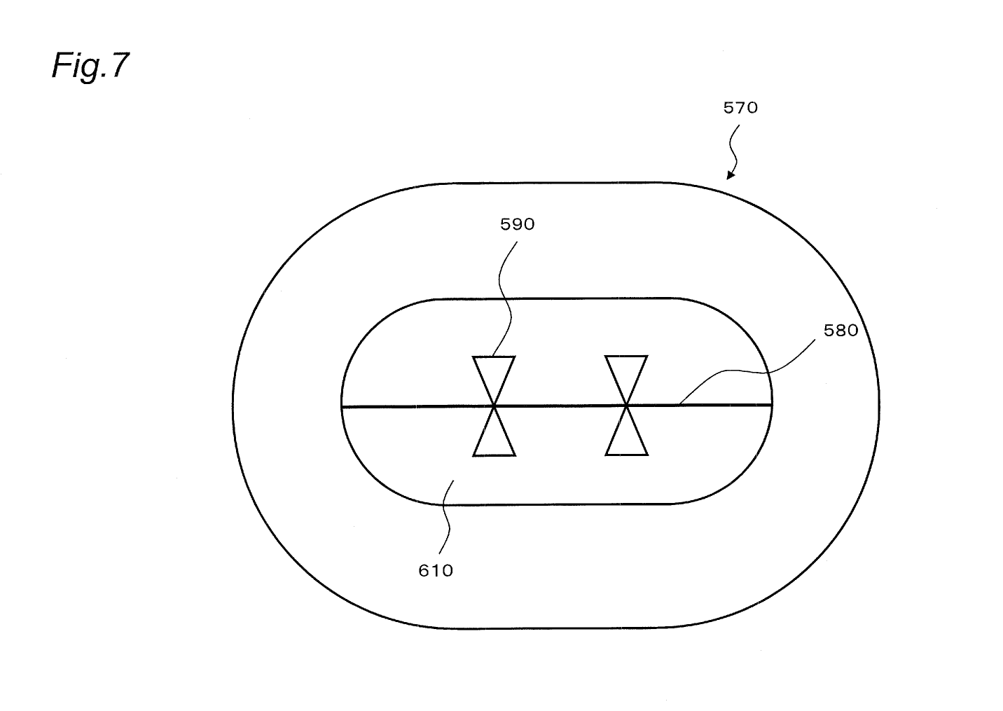

In the first embodiment, the lens cap 570 is attachable to the 3D conversion lens 500. Particularly in the state that the lens cap 570 is attached to the 3D conversion lens 500, the optical system 501 of the 3D conversion lens 500 can be adjusted. The lens cap 570 will be described below with reference to FIGS. 6A, 6B and 7. The lens cap 570 is attachable to the lens cap attaching portion 520. FIG. 6A is a perspective view illustrating a state that the lens cap 570 is viewed from an inner surface side. FIG. 6B is a perspective view illustrating a state that the lens cap 570 is viewed from an outer surface side. FIG. 7 is a schematic diagram illustrating the configuration of the lens cap 570 viewed from the surface opposed to the lens cap attaching portion 520 when the lens cap 570 is attached to the lens cap attaching portion 520.

The inner surface of the lens cap 570 is provided with a structure for defining an attaching position with respect to the 3D conversion lens 500 and preventing the rotation of the lens cap 570 with respect to the 3D conversion lens 500. Concretely, a protrusion 680 is formed at right and left of the inner surface of the lens cap 570. Further, a groove 670 is provided at right and left of an outer periphery of a front end of the 3D conversion lens 500 as shown in FIG. 1. When the lens cap 570 is attached to the 3D conversion lens 500, the protrusion 680 of the lens cap 570 is engaged with the groove 670 of the 3D conversion lens 500. As a result, the attaching position of the lens cap 570 with respect to the 3D conversion lens 500 is defined, and the rotation of the lens cap 570 with respect to the 3D conversion lens 500 can be prevented.

The lens cap 570 is provided with a pattern as shown in FIGS. 6A and 7. Concretely, the lens cap 570 is provided with a reference line 580 composed of a straight line. The reference line 580 is provided so as to be parallel to a horizontal direction of the digital video camera 100 in a state where the 3D conversion lens 500 is attached to the digital video camera 100, and the lens cap 570 is attached to the 3D conversion lens 500. The lens cap 570 is provided with a pattern 590 composed of two triangles arranged axisymmetrically with respect to the reference line 580. The pattern 590 is arranged in a bilaterally symmetrical manner with the midpoint of the reference line 580 being a center. A region 610 is composed of resin that transmits light. Therefore, the digital video camera 100 can capture the pattern shown in FIG. 7 with the lens cap 570 being attached to the lens cap attaching portion 520. Since the pattern 590 is the pattern composed of the two triangles, it has a line extending diagonally. For this reason, the pattern 590 has an advantage such that it is easily focused in a contrast AF system. The pattern does not have to be triangle as long as it has the line extending diagonally.

1-2. Configuration

1-2-1. Electrical Configuration

An electrical configuration of the digital video camera 100 according to the embodiment will be described with reference to FIG. 8. FIG. 8 is a block diagram illustrating a configuration of the digital video camera 100. The digital video camera 100 has an optical system 101, the CCD image sensor 180, an image processor 190, a liquid crystal display monitor 270, a detector 120, a zoom motor 130, an OIS actuator 150, another detector 160, a memory 200, a zoom lever 260, an operation member 250, an internal memory 280, a gyro sensor 220, a controller 210, an HDMI unit (not shown), and a card slot 230. In the digital video camera 100, the CCD image sensor 180 captures a subject image formed by the optical system 101. Video data generated by the CCD image sensor 180 is subject to various processes in the image processor 190, and is stored in the memory card 240. Further, the video data stored in the memory card 240 can be displayed on the liquid crystal display monitor 270.

The optical system 101 of the digital video camera 100 includes a zoom lens 110, an OIS 140, and a focus lens 170. The zoom lens 110 moves along an optical axis of the optical system 101 to be capable of enlarging or reducing a subject image. The focus lens 170 moves along the optical axis of the optical system 101 to adjust a focus of the subject image.

The OIS 140 has a correcting lens that can move in a plane vertical to the optical axis. The OIS 140 drives the correcting lens to a direction where a shake of the digital video camera 100 is cancelled to reduce a shake of a subject image.

The zoom motor 130 drives the zoom lens 110. The zoom motor 130 may be realized by a pulse motor, a DC motor, a linear motor, a servo motor or the like. The zoom motor 130 may drive the zoom lens 110 via a cam mechanism or a mechanism such as a ball screw. The detector 120 detects a position on the optical axis where the zoom lens 110 is present. The detector 120 outputs a signal relating to the position of the zoom lens through a switch such as a brush according to the transfer of the zoom lens 110 to an optically axial direction.

The OIS actuator 150 drives the correcting lens in the OIS 140 in a plane vertical to the optical axis. The OIS actuator 150 can be realized by a planar coil or an ultrasonic motor. The detector 160 detects a moving distance of the correcting lens in the OIS 140.

The CCD image sensor 180 captures a subject image formed by the optical system 101 composed of the zoom lens 110 to generate video data. The CCD image sensor 180 performs various operations such as exposure, transfer and an electronic shutter.

The image processor 190 executes the various processes on video data generated by the CCD image sensor 180 to generate video data to be displayed on the liquid crystal display monitor 270 or generate video data to be again stored in the memory card 240. For example, the image processor 190 executes various processes such as gamma correction, white balance correction and a scratch correction on the video data generated by the CCD image sensor 180. Further, the image processor 190 compresses the video data generated by the CCD image sensor 180 according to a compressing format in conformity with the H.264 standards or the MPEG2 standards. The image processor 190 decodes the compressed video data. The image processor 190 can be realized by a DSP or a microcomputer.

The controller 210 is a control unit for controlling the digital video camera 100 entirely. The controller 210 can be realized by a semiconductor element. The controller 210 may be composed of only hardware or a combination of hardware and software. The controller 210 can be realized by a microcomputer.

The memory 200 functions as a work memory of the image processor 190 and the controller 210. The memory 200 can be realized by, for example, a DRAM or a ferroelectric memory.

The liquid crystal display monitor 270 can display video represented by video data generated by the CCD image sensor 180 and video represented by video data read from the memory card 240.

The gyro sensor 220 is composed of an oscillation material such as a piezoelectric element. The gyro sensor 220 converts a force caused by a Coriolis force at a time of oscillating the oscillation material such as the piezoelectric element at a constant frequency into a voltage to obtain angular velocity information. The digital video camera 100 obtains the angular velocity information from the gyro sensor 220 and drives the correcting lens in the OIS to a direction where the shake is cancelled to correct a camera shake caused by the user.

The memory card 240 is attachable to the card slot 230. The card slot 230 can be mechanically and electrically connected to the memory card 240. The memory card 240 contains a flash memory or a ferroelectric memory to be capable of storing data.

The internal memory 280 is composed of a flash memory or a ferroelectric memory. The internal memory 280 stores a control program or the like for entirely controlling the digital video camera 100.

The operation member 250 is a member for receiving operations from the user. The zoom lever 260 is a member for receiving an instruction for changing a zoom magnification from the user.

The detection switch 800 can magnetically detect that the 3D conversion lens 500 is attached to the digital video camera 100. When the detection switch 800 detects that the 3D conversion lens 500 is attached, it sends a signal indicating that the 3D conversion lens 500 is attached to the controller 210. As a result, the controller 210 can detect that the 3D conversion lens 500 is attached to and detached from the digital video camera 100.

1-5. Operation

1-5-1. Operation in Case where the Attachment of the 3D Conversion Lens is Detected

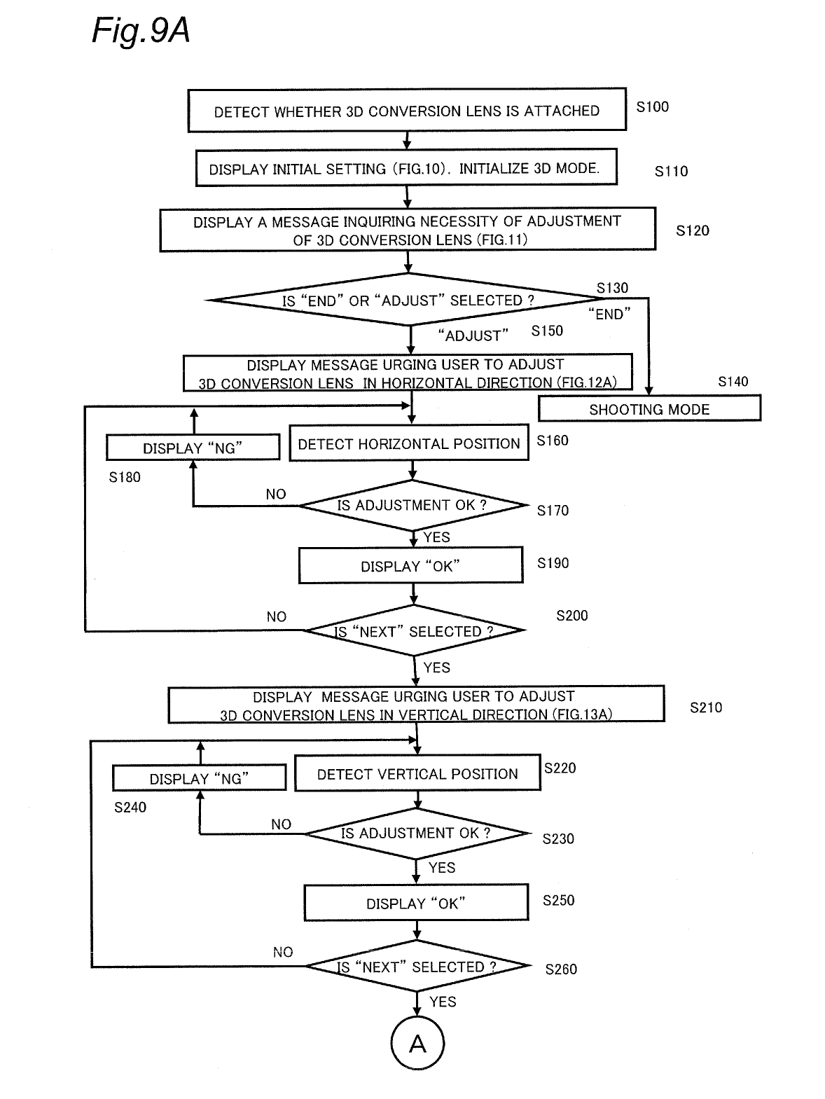

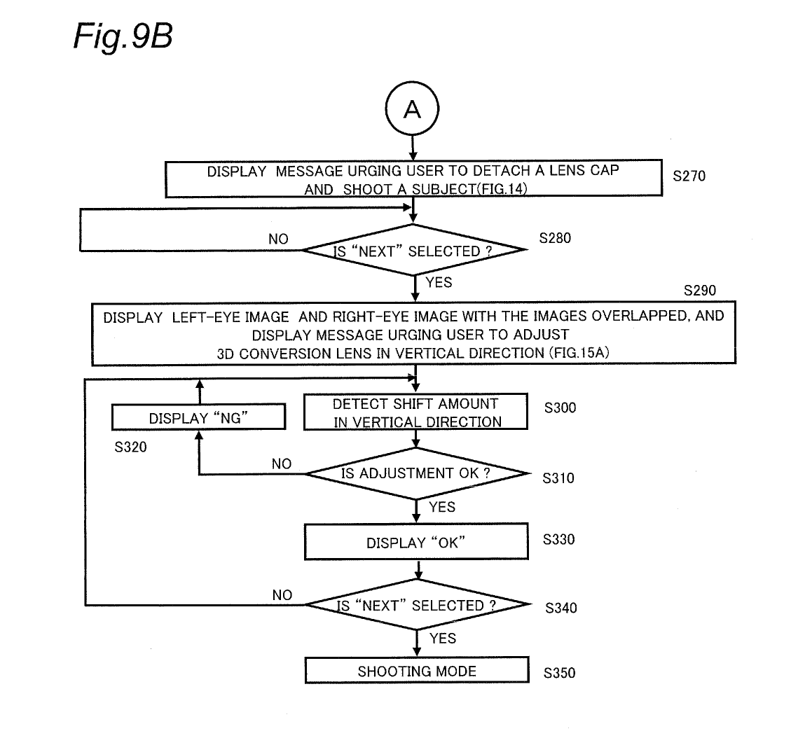

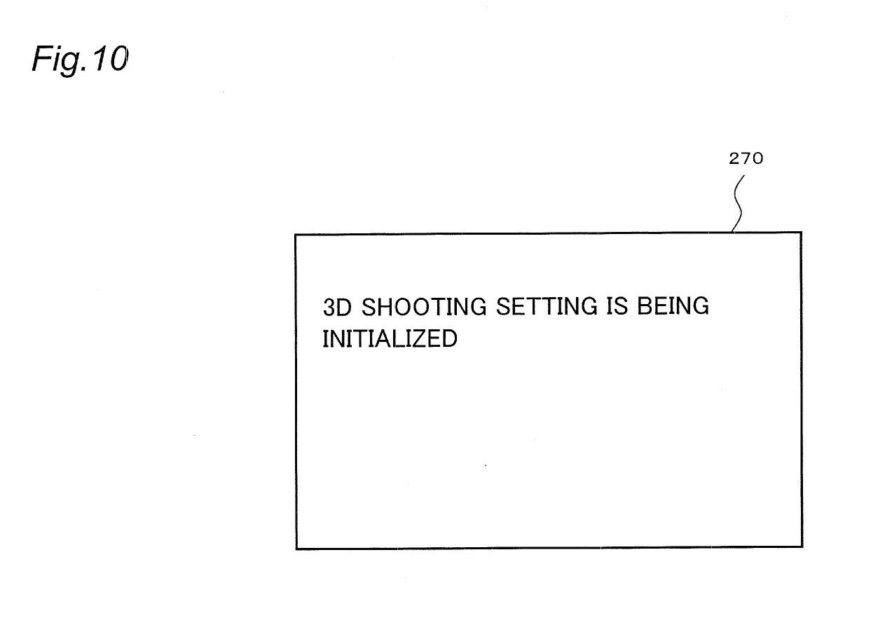

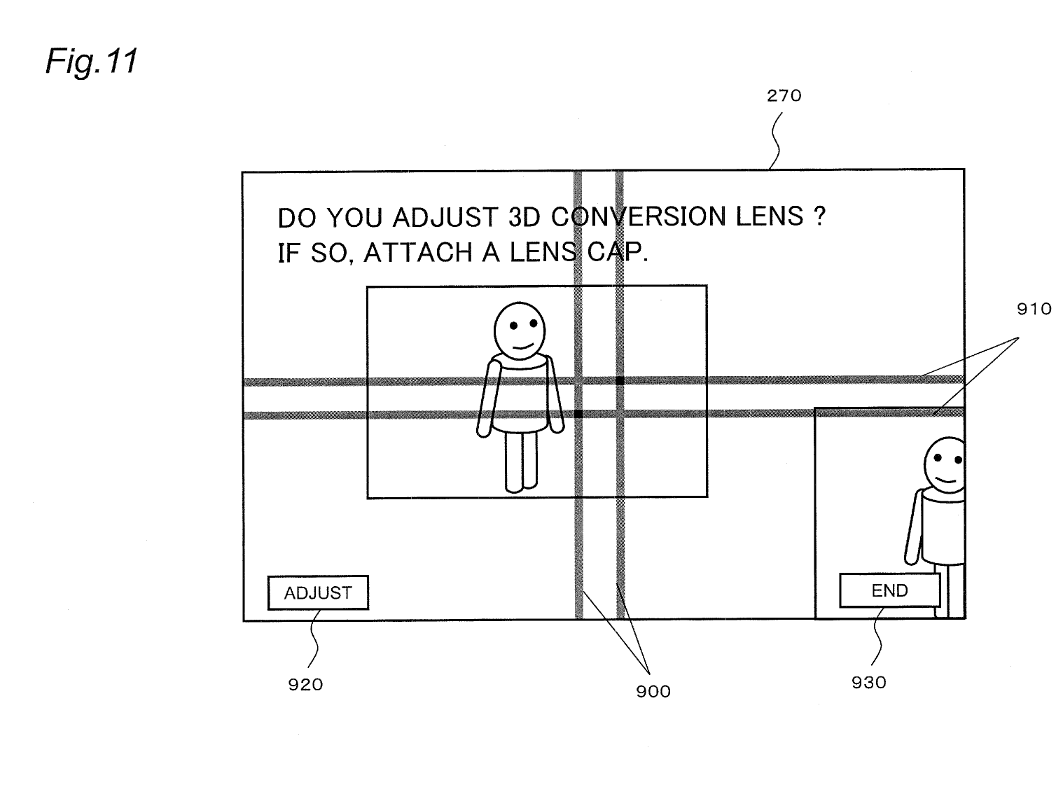

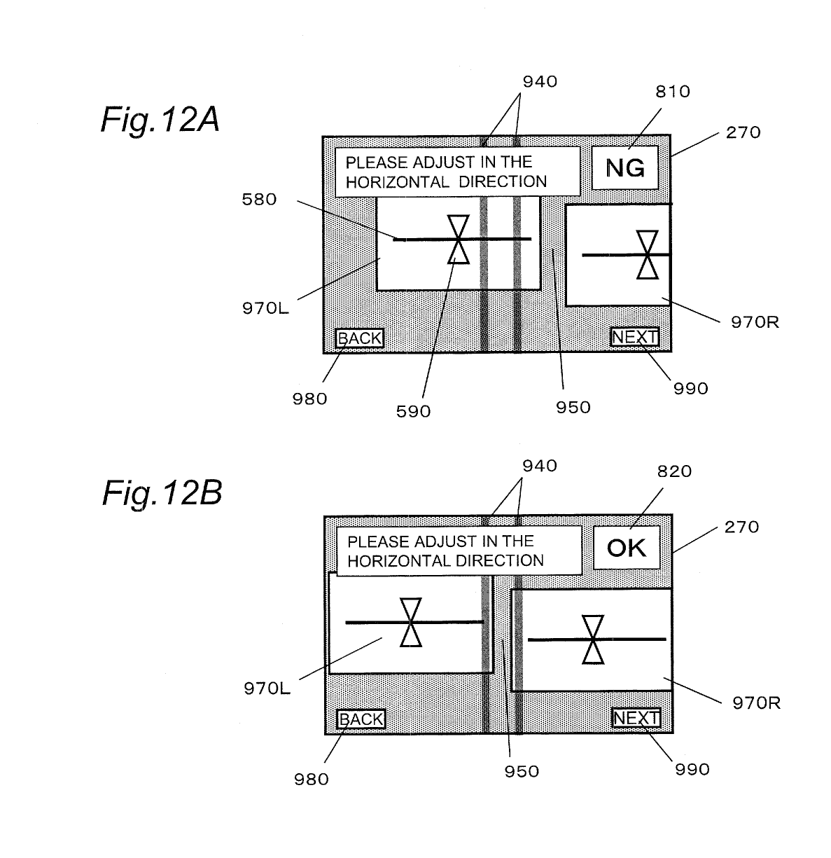

An operation for detecting the attachment of the 3D conversion lens 500 that is performed by the digital video camera 100 will be described with reference to FIGS. 9A to 12. FIGS. 9A and 9B is a flowchart illustrating the operation for detecting the attachment of the 3D conversion lens 500 performed by the digital video camera 100. FIG. 10 is a schematic diagram for describing a display content of the liquid crystal display monitor 270 at a time of initial setting. FIG. 11 is a schematic diagram for describing a display content of the liquid crystal display monitor 270 at a time when inquiry is made if the 3D conversion lens 500 is adjusted. FIGS. 12A to 15 are schematic diagrams for describing a display content of the liquid crystal display monitor 270 at a time of adjusting the 3D conversion lens 500.

When the user attaches the 3D conversion lens 500 to the digital video camera 100, the controller 210 detects that the 3D conversion lens 500 is attached based on a detection signal from the detection switch 800 (S100). When detecting that the 3D conversion lens 500 is attached, the controller 210 controls the liquid crystal display monitor 270 to display a message shown in FIG. 10 (S110). Concretely, “3D shooting is being initialized” is displayed. According to the display of the message on the liquid crystal display monitor 270, the controller 210 controls the digital video camera 100 so that the initialization in a 3D mode starts (S110). Concretely, the controller 210 carries out the initialization so that the zoom lens 110 moves to a telephoto end or/and a method of the image process is set to a method different from a 2D image shooting mode. The message displayed in FIG. 10 is one example. The content of the message may be different but preferably has similar gist.

When the initialization is completed, the controller 210 controls the liquid crystal display monitor 270 to display a message shown in FIG. 11 (S120). Concretely, the controller 210 makes an inquiry if the position of the 3D conversion lens 500 is adjusted in a manner that, for example, “Is the 3D conversion lens adjusted? If so, attach a lens cap.” is displayed. When the adjustment is made, the message urging the user to attach the lens cap is displayed. Further, the controller 210 controls the liquid crystal display monitor 270 to display OSD shown in FIG. 11 Concretely, the controller 210 controls the liquid crystal display monitor 270 to display a horizontal direction reference line 910 and a vertical direction reference line 900. The controller 210 controls the liquid crystal display monitor 270 to display OSD 920 indicating “Adjust” for receiving an operation from the user and OSD 930 indicating “End” to display.

When controlling the liquid crystal display monitor 270 to display an image shown in FIG. 11, the controller 210 stands by until the OSD 920 indicating “Adjust” or the OSD 930 indicating “End” are touched by the user (S130).

When the OSD 930 indicating “End” is selected by the user, the controller 210 shifts into the shooting mode (S140) and stands by until it receives a shooting start instruction form the user. On the other hand, when the image shown in FIG. 11 is displayed and the OSD 920 indicating “Adjust” is selected by the user, the controller 210 shifts into an adjusting mode. This adjusting mode includes a first adjusting mode for adjusting a position where any one of a left-eye image and a right-eye image is formed, and a second mode for aligning the position of the other image in the vertical direction with the position of the one image in the vertical direction adjusted by the first mode. The first embodiment describes a case where the position where a right-eye image is formed in the first mode is adjusted, and the position in the vertical direction where a left-eye image is formed in the second mode. However, the position where a left-eye image is formed may be adjusted in the first mode, and the position in the vertical direction where a right-eye image is formed may be adjusted in the second mode.

The controller 210 first executes the first adjusting mode. That is to say, the controller 210 controls the liquid crystal display monitor 270 to display an image shown in FIG. 12A (S150). It is assumed that, after the user recognizes the image shown in FIG. 11 when the position of the 3D conversion lens 500 is adjusted, the lens cap 570 is attached to the digital video camera 100. Concretely, the controller 210 controls the liquid crystal display monitor 270 to display two vertical direction reference lines 940. The controller 210 controls the liquid crystal display monitor 270 to display a left-eye image 970L and a right-eye image 970R captured by the CCD image sensor 180. The controller 210 controls the liquid crystal display monitor 270 to display message “Adjust in the horizontal direction”. The user can move the left-eye image 970L and the right-eye image 970R in the horizontal direction and thus a region 950 that is present between the images 970L and 970R can be moved to the horizontal direction by operating the horizontal adjustment dial 540. The user can adjust the positions of the right-eye lens 600 and the left-eye lens 620 in the horizontal direction by moving the region 950 between the two vertical direction reference lines 940. The digital video camera 100 captures the pattern 590. The digital video camera 100 can carry out focusing on the pattern 590 according to AF in a contrast system. As a result, the digital video camera 100 can carry out focusing also on the reference line 580.

The controller 210 detects a horizontal position of the region (S160), and determines whether the region 950 is between the vertical reference lines 940 to determine whether horizontal positions of the right-eye lens 600 and left-eye lens 620 are adjusted (S170). More concretely, the controller 210 analyzes a position of the center line of the region 950 from the captured image, to grasp a position in a plane where the center line of the region 950 is present. The controller 210 comparatively calculates whether the position of the region 950 (the position of the center line) grasped by the analysis of the captured image is between the vertical reference lines 940 of which position is grasped in advance, to determine whether the horizontal positions of the right-eye lens 600 and the left-eye lens 620 are adjusted.

For example, as shown in FIG. 12A, when the region 950 is not between the vertical reference lines 940, the controller 210 determines that the horizontal positions of the right-eye lens 600 and the left-eye lens 620 are not adjusted. At this time, in order to present the state that the horizontal positions of the right-eye lens 600 and the left-eye lens 620 are not adjusted to the user, the controller 210 displays an OSD 810 indicating “NG” on the liquid crystal display monitor 270 (S180). On the other hand, as shown in FIG. 12B, when the region 950 is between the vertical reference lines 940, the controller 210 determines that the horizontal positions of the right-eye lens 600 and the left-eye lens 620 are suitably adjusted. At this time, in order to present the state that the horizontal positions of the right-eye lens 600 and left-eye lens 620 are suitably adjusted to the user, the controller 210 displays an OSD 820 indicating “OK” on the liquid crystal display monitor 270 (S190). The controller 210 shows the state that the suitable adjustment is made on the liquid crystal display monitor 270 according to whether the region 950 is within the vertical reference lines 940. As a result, the user who operates the horizontal adjustment dial 540 can easily determine whether a position that is being currently adjusted is suitable.

When the OSD 820 indicating “OK” is displayed on the liquid crystal display monitor 270, the controller 210 determines whether an OSD 990 indicating “next” is touched by the user (S200).

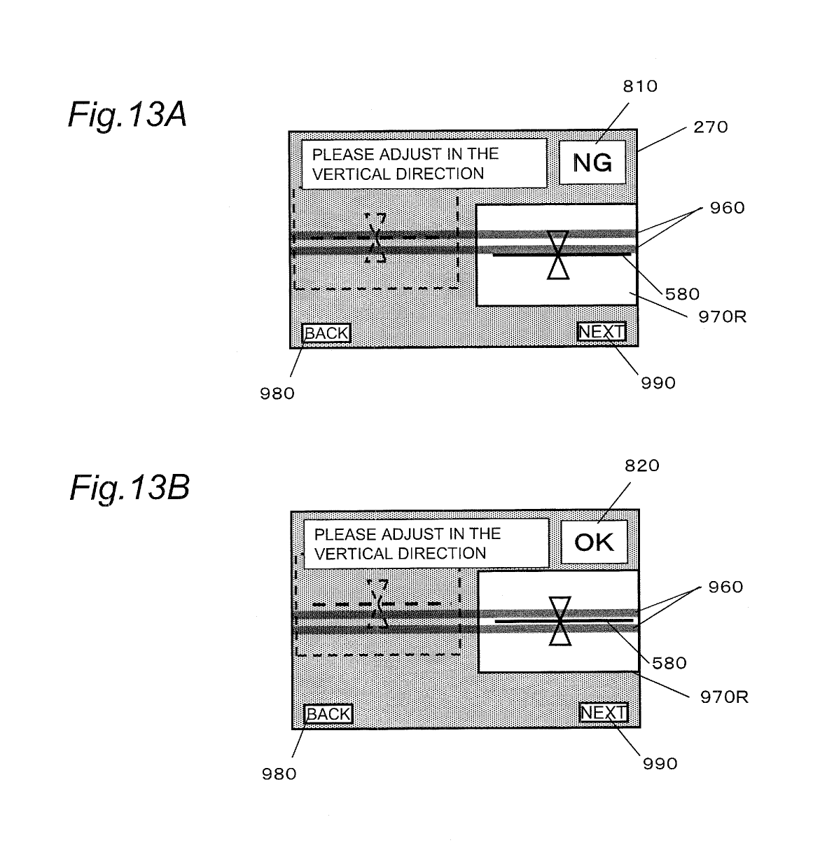

When the OSD 990 indicating “Next” is touched by the user, the controller 210 controls the liquid crystal display monitor 270 to display the image shown in FIG. 13A (S210). Concretely, the controller 210 controls the liquid crystal display monitor 270 to display the two horizontal direction reference lines 960. Further, the controller 210 controls the liquid crystal display monitor 270 to display only the right-eye image 970R of the images captured by the CCD image sensor 180. Only the right-eye image 970R is displayed because if both the right-eye image 970R and the left-eye image 970L are displayed, the user might lose perception of which image should be adjusted. The controller 210 controls the liquid crystal display monitor 270 to display message “Adjust in the vertical direction”. The user operates the second vertical adjustment dial 560 to be capable of moving the right-eye image 970R to the vertical direction. The user can adjust the position of the right-eye lens 600 in the vertical direction by moving the reference line 580 between the two horizontal direction reference lines 960.

When a portion other than the OSD 990 indicating “Next” is touched by the user, the controller 210 executes the processes after Step S220 again. It is noted that the controller 210 executes the processes after, for example, Step S160 again when the OSD 980 indicating “Back” is touched by the user.

When controlling the liquid crystal display monitor 270 to display the image shown in FIG. 13A, the controller 210 detects a vertical position of the reference line 580 (S220), and determines whether the reference line 580 is between the horizontal direction reference lines 960 to determine whether vertical positions of the right-eye lens 600 and left-eye lens 620 are adjusted (S230). More concretely, the controller 210 analyzes a position of the reference line 580 from the captured image, to grasp a position in a plane where the reference line 580 is present. The controller 210 comparatively calculates whether the position of the reference line 580 grasped by the analysis of the captured image is between the horizontal direction reference lines 960 of which position is grasped in advance, to determine whether the vertical positions of the right-eye lens 600 and the left-eye lens 620 are adjusted.

For example, as shown in FIG. 13A, when the reference line 580 is not between the horizontal direction reference lines 960, the controller 210 determines that the vertical positions of the right-eye lens 600 and the left-eye lens 620 are not adjusted. At this time, in order to present the state that the vertical positions of the right-eye lens 600 and the left-eye lens 620 are not adjusted to the user, the controller 210 displays an OSD 810 indicating “NG” on the liquid crystal display monitor 270 (S240). On the other hand, as shown in FIG. 13B, when the reference line 580 is between the horizontal direction reference lines 960, the controller 210 determines that the vertical positions of the right-eye lens 600 and the left-eye lens 620 are suitably adjusted. At this time, in order to present the state that the vertical positions of the right-eye lens 600 and left-eye lens 620 are suitably adjusted to the user, the controller 210 displays an OSD 820 indicating “OK” on the liquid crystal display monitor 270 (S250). The controller 210 shows the state that the suitable adjustment is made on the liquid crystal display monitor 270 according to whether the reference line 580 is within the horizontal direction reference lines 960. As a result, the user who operates the first vertical adjustment dial 550 can easily determine whether a position that is being currently adjusted is suitable.

When the OSD 820 indicating “OK” is displayed on the liquid crystal display monitor 270, the controller 210 determines whether an OSD 990 indicating “next” is touched by the user (S260).

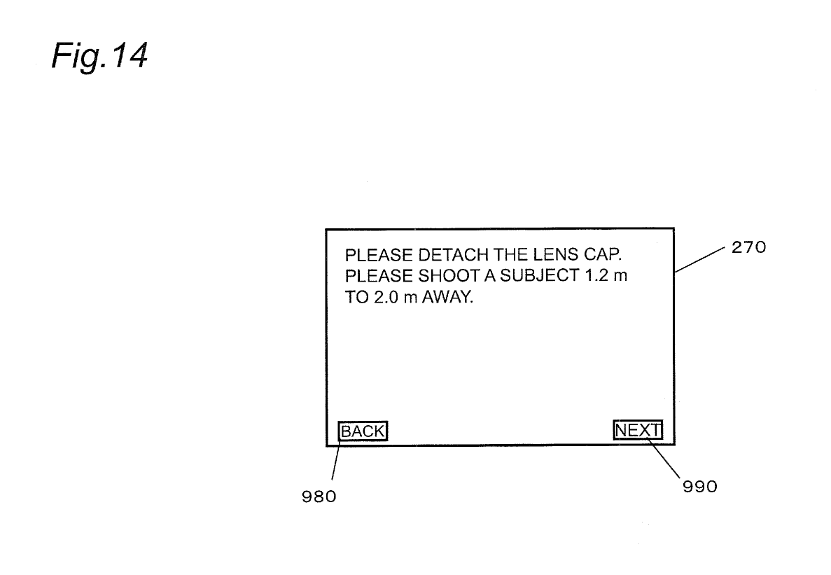

When the OSD 990 indicating “Next” is touched by the user, the controller 210 executes the second adjusting mode. That is to say, the controller 210 controls the liquid crystal display monitor 270 to display the image shown in FIG. 14 (S270). Concretely, the controller 210 controls the liquid crystal display monitor 270 to display a message “Detach the lens cap. Shoot a subject 1.2 m to 2.0 m away”.

When a portion other than the OSD 990 indicating “Next” is touched by the user, the controller 210 executes the processes after Step S220 again. It is noted that the controller 210 executes the processes after, for example, Step S160 again when the OSD 980 indicating “Back” is touched by the user.

When controlling the liquid crystal display monitor 270 to display the image shown in FIG. 14, the controller 210 determines whether an OSD 990 indicating “next” is touched by the user (S280).

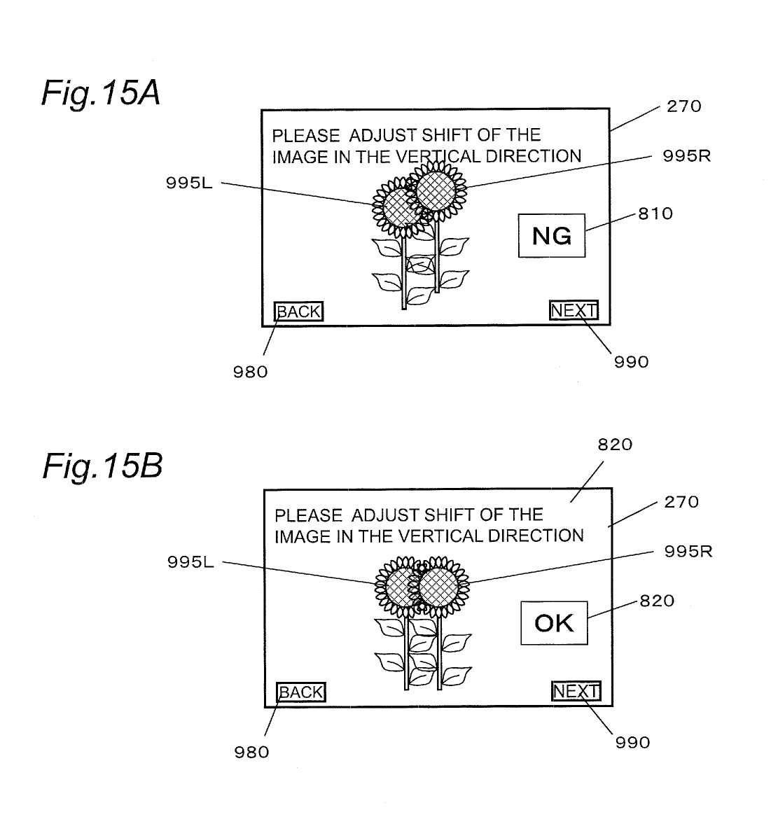

When the OSD 990 indicating “next” is touched by the user, the controller 210 controls the liquid crystal display monitor 270 to display an image shown in FIG. 15A (S290). Concretely, the controller 210 controls the liquid crystal display monitor 270 to enlarge the left-eye image 995L and the right-eye image 995R in horizontal and vertical directions into a size according to the number of pixels of the liquid crystal display monitor 270 and overlap to be displayed. Further, the controller 210 controls the liquid crystal display monitor 270 to display message “adjust shift of the image in the vertical direction”. The user can move the left-eye image 995L in the vertical direction by operating the second vertical adjustment dial 560. The user can adjust the position of the left-eye lens 620 in the vertical direction by moving the position of the left-eye image 995L in the vertical direction to the position of the right-eye image 995R in the vertical direction. That is to say, the user can adjust shift between the left-eye image 995L and the right-eye image 995R in the vertical direction caused by a tilt of the 3D conversion lens 500 with respect to the CCD image sensor 180 by performing such an operation. When the 3D conversion lens 500 is attached to the digital video camera 100 in a tilted manner, a captured image also tilts, but this tilt becomes shift of the left-eye image and the right-eye image in an up-down direction at a time when the user views the image. This tires the user who views 3D images. However, in this embodiment, adoption of the above constitution can prevent such a defect.

When a portion other than the OSD 990 indicating “Next” is touched by the user, the controller 210 executes the processes of Step S280 again. It is noted that the controller 210 executes the processes after, for example, Step S220 again when the OSD 980 indicating “Back” is touched by the user.

The image processor 190 executes a matching process between the left-eye image 995L and the right-eye image 995R generated as needed. The image processor 190 notifies the controller 210 of a matching result of the current left-eye image 995L and right-eye image 995R at the present time as needed. The controller 210 detects shift (amount) between the left-eye image 995L and the right-eye image 995R in the vertical direction based on the matching result (S300), and determines whether the shift amount is larger than a predetermined reference value (S310).

FIG. 15A is a diagram illustrating an image at a time when the determination is made based on the matching result from the image processor 190 that the shift between the left-eye image 995L and the right-eye image 995R in the vertical direction is larger than the predetermined reference value. At this time, since the shift between the left-eye image 995L and the right-eye image 995R in the vertical direction is larger than predetermined reference value, the controller 210 determines that the vertical position of one lens (the left-eye lens 620) is not adjusted. At this time, in order to present the state that the vertical position of one lens is not adjusted to the user, the controller 210 displays the OSD 810 indicating “NG” on the liquid crystal display monitor 270 (S320). On the other hand, as shown in FIG. 15B, when the determination is made that the shift between the left-eye image 995L and the right-eye image 995R in the vertical direction is smaller than the predetermined reference value, the controller 210 determines that the vertical position of one lens is suitably adjusted. At this time, in order to present the state that the vertical position of one lens can be suitably adjusted to the user, the controller 210 displays the OSD 820 indicating “OK” on the liquid crystal display monitor 270 (S330). As described above, the controller 210 presents whether the shift between the left-eye image 995L and the right-eye image 995R in the vertical direction is suitably adjusted according to the result of comparison with the predetermined reference value on the liquid crystal display monitor 270. As a result, the user who operates the second vertical adjustment dial 540 can easily determine whether the position being currently adjusted is suitable.

When the OSD 820 indicating “OK” is displayed on the liquid crystal display monitor 270, the controller 210 determines whether an OSD 990 indicating “next” is touched by the user (S340).

When the OSD 990 indicating “Next” is touched, the controller 210 controls the digital video camera 100 entirely so that the digital video camera 100 shifts into the shooting mode (S350).

When a portion other than the OSD 990 indicating “Next” is touched by the user, the controller 210 executes the processes after Step S300 again. It is noted that the controller 210 executes the processes after, for example, Step S270 again when the OSD 980 indicating “Back” is touched by the user.

1-6. Effect and the Like

As described above, the digital video camera 100 can be attached to a 3D conversion lens 500. The digital video camera 100 includes:

a CCD image sensor 180 that captures a subject image formed by the attached 3D conversion lens 500 and generates an image data;

a liquid crystal display monitor 270 that displays an image based on the generated image data;

an adjustment mechanism housing unit 530 that adjusts a lens position of an optical system 501 included in the attached 3D conversion lens 500;

a controller 210 that:
(i) determines that a predetermined portion of the subject image, moved according to the adjustment of the lens position is, at least one of (a) within a predetermined range in the image and (b) not within the predetermined range in the image; and
i) causes the liquid crystal display monitor 270 display the determined result.

With this configuration, when the user adjusts the lens position of the optical system 501 included in the 3D conversion lens 500, determination whether the adjustment is appropriate is made by the digital video camera 100, and a determined result is displayed on the liquid crystal display monitor 270. For this reason, the user can easily determine whether the adjustment is appropriate.

In the present disclosure, when the predetermined portion of the subject image is within the predetermined range in the image, the controller causes the liquid crystal display monitor 270 to display, as the determined result, a message that indicates that satisfactory adjustment is made and when the predetermined portion of the subject image is not within the predetermined range in the image, the controller causes the liquid crystal display monitor 270 to display, as the determined result, a message that indicates that satisfactory adjustment is not made on the liquid crystal display monitor 270.

With this configuration, the user can easily determine whether the adjustment of the 3D conversion lens 500 is appropriate, based on the display indicating whether or not satisfactory adjustment is made on the liquid crystal display monitor 270.

In the present disclosure,

the optical system 501 of the 3D conversion lens 500 includes a left-eye lens 620 to form a left-eye subject image and a right-eye lens 600 to form a right-eye subject image, and forms the left-eye subject image formed by the left-eye lens 620 and the right-eye subject image formed by the right-eye lens 600 on the CCD image sensor 180 in a side-by-side format,

the adjustment mechanism housing unit 530 integrally adjusts lens positions of the left-eye lens 620 and the right-eye lens 600 in a horizontal direction, and

the controller 210 determines that a region 950 between the subject image formed by the left-eye lens 620 and the subject image formed by the right-eye lens 600 is within a region between the vertical direction reference lines 940 (predetermined range) in the image in the horizontal direction.

With this configuration, when the user adjusts the horizontal positions of the left-eye lens 620 and the right-eye lens 600, the digital video camera 100 determines whether the adjustment is good or bad, and the determined result is displayed on the liquid crystal display monitor 270. For this reason, the user can easily determine whether the adjustment of the horizontal position is good or bad.

In the present disclosure,

the optical system 501 of the 3D conversion lens 500 includes a left-eye lens 620 to form a left-eye subject image and a right-eye lens 600 to form a right-eye subject image, and forms the left-eye subject image formed by the left-eye lens 620 and the right-eye subject image formed by the right-eye lens 600 on the CCD image sensor 180 in a side-by-side format,

the adjustment mechanism housing unit 530 adjusts lens positions of the left-eye lens 620 and the right-eye lens 600 in a vertical direction,

the controller 210 determines that a predetermined portion between the subject image formed by the left-eye lens 620 and the subject image formed by the right-eye lens 600 is within the predetermined range in the image in the vertical direction.

With this configuration, when the user adjusts the vertical positions of the left-eye lens 620 and the right-eye lens 600, the digital video camera 100 determines whether the adjustment is appropriate, and the determined result is displayed on the liquid crystal display monitor 270. For this reason, the user can easily determine whether the adjustment of the vertical positions is appropriate.

In the present disclosure,

the optical system 501 of the 3D conversion lens 500 includes a left-eye lens 620 to form a left-eye subject image and a right-eye lens 600 to form a right-eye subject image, and forms the left-eye subject image formed by the left-eye lens 620 and the right-eye subject image formed by the right-eye lens 600 on the CCD image sensor 180 in a side-by-side format,

the 3D conversion lens 500 has a lens cap 570 attachable to the 3D conversion lens 500 in a predetermined positional relationship,

the lens cap 570 has a pattern for adjustment of the lens position, the pattern being parallel with a horizontal direction of the digital video camera 100 in a state where the 3D conversion lens 500 is attached to the digital video camera 100, and the lens cap 570 is attached to the 3D conversion lens 500,

the adjustment mechanism housing unit 530 adjusts lens positions of the left-eye lens 620 and the right-eye lens 600 in a vertical direction independently and integrally,

the controller 210 that:
(i) determines that the pattern for adjustment of the lens position included in the subject image formed on the CCD image sensor 180 by one of the left-eye lens 620 and the right-eye lens 600 is within the predetermined range in the image in the vertical direction in a state that the lens cap 570 is attached and the adjustment mechanism housing unit 530 adjusts the lens positions of the left-eye lens 620 and the right-eye lens 600 in the vertical direction integrally,
(ii) determines that a shift amount in the vertical direction between the left-eye subject image formed by the left-eye lens 620 on the CCD image sensor 180 and the right-eye subject image formed by the right-eye lens 600 on the CCD image sensor 180 is smaller than a predetermined amount in a state that the lens cap 570 is not attached and the adjustment mechanism housing unit 530 adjusts the lens position of the other one of the left-eye lens 620 and the light-eye lens independently.

With this configuration, when the user adjusts the vertical positions of the left-eye lens 620 and the right-eye lens 600, the digital video camera 100 determines whether the adjustment is good or bad, and the determined result is displayed on the liquid crystal display monitor 270. For this reason, the user can easily determine whether the adjustment of the vertical positions is good or bad. Particularly, according to the present disclosure, since the lens positions in the vertical direction can be adjusted independently and integrally, the vertical positions of the left-eye lens 620 and the right-eye lens 600 can be adjusted to match with each other, but the above effect can be obtained even in this case.

In the present disclosure,

the pattern for the lens position adjustment of the lens cap 570 includes a line diagonally intersecting with a horizontal direction of the digital video camera 100 in a state that the lens cap 570 is attached to the 3D conversion lens 500.

With this configuration, focusing on the pattern for the lens position adjustment is easily carried out in a contrast AF system.

### 4. Another Embodiment

Generally, the above embodiment concerns an imaging apparatus 100 configured to be attached to a 3D conversion lens 500 including a lens adjusting unit 550 operable to adjust a lens position of an optical system 501 included in the attached 3D conversion lens. The imaging apparatus includes an internal memory 280, a liquid crystal display monitor 270 and a controller 210 coupled to the memory 280 and the display unit 210. The controller 210 is configured by instructions associated with a program stored in the internal memory 280 to: store a captured image from the 3D conversion lens in a work memory 200, the captured image including a left-eye image 970L and a right-eye image 970R; display the captured image on the liquid crystal display monitor 270 with one or more boundary lines 900, 910 overlaying the captured image; determine that the left-eye image 970L and the right-eye image 970R are properly aligned with respect to the one or more boundary lines 940; and display a message 810, 820 on the display in accordance with the determination of that the left-eye image and the right-eye image are properly aligned with respect to the one or more boundary lines.

The one or more boundary lines overlaid on the captured image include a boundary line 940 for defining horizontal alignment of a left-eye lens 620 and a right-eye lens 600 included in the optical system of the 3D conversion lens.

The one or more boundary lines overlaying the captured image include a boundary line 960 for defining vertical alignment of a left-eye lens 620 and a right-eye lens 600 included in the optical system of the 3D conversion lens.

The controller 210 is further configured by the instructions stored in the internal memory to: store another captured image from the 3D conversion lens in the work memory 200 including a left-eye image 995L and a right-eye image 995R; display the another captured image on the display unit with one of the left-eye image and the right-eye image overlapping the other of the left-eye image and the right-eye image; determine that a shift amount between vertical positions of the left-eye image and the right-eye image are greater than a predetermined amount associated with proper vertical alignment of a left-eye lens and a right-eye lens image included in the optical system of the 3D conversion lens; and display a message 810, 820 on the display in accordance with the determined shift amount.

The 3D conversion lens 500 to which the imaging apparatus 100 is configured to be attached to is configured to be attached to a lens cap 570. The lens cap 570 is provided with a pattern including a reference line 580 substantially in parallel to a horizontal direction of the imaging apparatus when the 3D conversion lens 500 is attached to the imaging apparatus 100.

The controller 210 is further configured to determine that the left-eye image and the right-eye image are properly aligned with respect to the one or more boundary lines by checking the position of the reference with respect to the one or more boundary lines.

The above embodiment has been described above by an example of the technique disclosed by the present application. However, the technique according to the present disclosure is not limited to the above embodiment, and can be applied to embodiments that are appropriately configured by modification, replacement, addition, and omission. Further, it is possible to provide another embodiment by combining components described in the first embodiment.

Thus, other embodiments will now be described by an example.

The optical system 501 and the driving system of the digital video camera 100 according to another embodiment are not limited to ones shown in FIG. 8. For example, FIG. 8 illustrates the optical system 501 having three-group configuration but it may have another group configuration of lenses. Further, the respective lenses may be composed of one lens, or may be composed of a lens group having a plurality of lenses.

The first to third embodiments illustrate the CCD image sensor 180 as an image pickup unit, but the present disclosure is not limited to this. For example, the image pickup unit may be composed of a CMOS image sensor or an NMOS image sensor.

In the above embodiment, a message shown in FIG. 11 such that “attach the lens cap” urges the user to attach the lens cap 570. At this time, the detection switch 800 detects whether the lens cap 570 is actually attached. However, the attachment of the lens cap 570 may be checked by analysis of a captured image (identification of a pattern given to the lens cap 570). At this time, when non-attachment of the lens cap 570 is recognized, a screen may be displayed that informs the user that the lens cap 570 should be attached. In another manner, when non-attachment of the lens cap 570 is recognized, the operation may be regulated not to shift to the adjustment screen in FIG. 12.

In the above embodiment, the left-eye lens 620 is adjusted in the vertical direction by the second lens vertical adjustment dial 560, but the present disclosure is not limited to this, and the right-eye lens 600 may be adjusted by the second lens vertical adjustment dial 560. When the right-eye lens 600 is adjusted by operating the second lens vertical adjustment dial 560, as to the determination of the adjustment of both the left-eye lens 620 and the right-eye lens 600 in the vertical direction described with reference to FIG. 13, the determination is made whether the left-eye image 970L is within the reference lines.

In the above embodiment, the second vertical adjustment dial 560 manually adjustable by the user is provided, but the present disclosure is not limited to this. The vertical shift between left-eye image and the right-eye image may be automatically adjusted by the image process of the image processor 190.

In the above embodiment, the state that the suitable adjustment is not made is indicated by the OSD 810 indicating “NG”, but the present disclosure is not limited to this. Another expression may be provided as long as it indicates that the suitable adjustment is not made. Further, in addition to the state that the suitable adjustment is not made, the direction in which the adjustment should be made may be also displayed. For example, shift to right or left is indicated to urge the user to adjust the shift. In the above embodiment, the state that suitable adjustment is not made is displayed, or it may be informed by a sound or by activating a light.

In the above embodiment, in the adjustment of 3D conversion lens 500, when a captured image of the lens cap 570 is dark due to a dark photographing environment, the adjustment sometimes cannot be made by image analysis in some cases. For this reason, when illuminance is lower than a predetermined reference value, an image for urging the user to make the adjustment in a bright environment may be displayed.

In the above embodiment, in the adjustment of the vertical shift between right and left, when a contrast value of a subject included in a captured image is small, sufficient subject information sometimes cannot be obtained, and thus matching between right and left might fail. For this reason, when the contrast value of a subject is smaller than the predetermined reference value, a screen for urging the user to shoot a subject with higher contrast may be shown.

In the above embodiment, the shift from the screen in FIG. 12 into the screen in FIG. 13, the shift from the screen in FIG. 13 into the screen in FIG. 14, and the shift from the screen in FIG. 14 into the screen in FIG. 15 are carried out by user's pressing-down of OSD “Next”, but the present disclosure is not limited to this. That is to say, when adjustment of a previous adjustment item is not suitably made, shift into a screen of a next adjustment item may be regulated not to occur. The present disclosure may be configured so that the screen may only shift into a screen of a next adjustment item when adjustment of a previous adjustment item is suitably made. As a result, the user can suitably adjust the optical system 501 of the 3D conversion lens 500 attached to the digital video camera 100.

As described above, as an exemplification of a technique in the disclosure, embodiments have been described. For this purpose, the accompanying drawings and the detailed description have been provided.

Thus, the constituent elements described in the accompanying drawings and the detailed description can include not only constituent elements that are required for solving the problems but also, in order to illustrate the above technique, constituent elements that are not required for solving the problem. For this reason, although the nonessential constituent elements are described in the accompanying drawings and the detailed description, it should not be authorized that the nonessential constituents are required.

In addition, since the embodiment illustrates the technique in the disclosure, various changes, replacements, additions, omissions and the like can be made in the scope of claims or a scope equivalent thereto.

### INDUSTRIAL APPLICABILITY

The present disclosure can be applied to imaging apparatuses capable of capturing 3D images. Concretely, the present disclosure can be applied to imaging apparatuses such as digital video cameras and digital still cameras.

What is claimed is:

1. An imaging apparatus to which a 3D conversion lens can be attached, comprising:
an imaging sensor that captures a subject image formed by the attached 3D conversion lens and generates an image data;
a display device that displays an image based on the generated image data;
a lens adjusting unit that adjusts a lens position of an optical system included in the attached 3D conversion lens;
a controller that:
(i) determines that a predetermined portion of the subject image, moved according to the adjustment of the lens position, is at least one of within a predetermined range in the image and (b) not within the predetermined range in the image; and
(ii) causes the display device to display the determined result.

2. The imaging apparatus according to claim 1, wherein when the predetermined portion of the subject image is within the predetermined range in the image, the controller causes the display device to display, as the determined result, a message that indicates that satisfactory adjustment is made and when the predetermined portion of the subject image is not within the predetermined range in the image, the controller causes the display device to display, as the determined result, a message that indicates that satisfactory adjustment is not made on the display device.

3. The imaging apparatus according to claim 1, wherein
the optical system of the 3D conversion lens includes a left-eye lens to form a subject image for a left-eye and a right-eye lens to form a subject image for a right-eye, and forms the subject image formed by the left-eye lens and the subject image formed by the right-eye lens on the imaging sensor in a side-by-side format,
the lens adjusting unit integrally adjusts lens positions of the left-eye lens and the right-eye lens in a horizontal direction, and
the controller determines that a region between the subject image formed by the left-eye lens and the subject image formed by the right-eye lens is within the predetermined range in the image in the horizontal direction.

4. The imaging apparatus according to claim 1, wherein
the optical system of the 3D conversion lens includes a left-eye lens to form a subject image for a left-eye and a right-eye lens to form a subject image for a right-eye, and forms the subject image formed by the left-eye lens and the subject image formed by the right-eye lens on the imaging sensor in a side-by-side format,
the lens adjusting unit adjusts lens positions of the left-eye lens and the right-eye lens in a vertical direction,
the controller determines that a predetermined portion between the subject image formed by the left-eye lens and the subject image formed by the right-eye lens is within the predetermined range in the image in the vertical direction.

5. The imaging apparatus according to claim 1, wherein
the optical system of the 3D conversion lens includes a left-eye lens to form a subject image for a left-eye and a right-eye lens to form a subject image for a right-eye, and forms the left-eye subject image formed by the left-eye lens and the right-eye subject image formed by the right-eye lens on the imaging sensor in a side-by-side format,
the 3D conversion lens has a lens cap attachable to the 3D conversion lens in a predetermined positional relationship,
the lens cap has a pattern for adjustment of the lens position, the pattern being parallel with a horizontal direction of the imaging apparatus in a state where the 3D conversion lens is attached to the digital video camera and the lens cap is attached to the 3D conversion lens,
the lens adjusting unit adjusts lens positions of the left-eye lens and the right-eye lens in a vertical direction independently and integrally,
the controller that:
(i) determines that the pattern for the adjustment of the lens position included in the subject image formed on the imaging sensor by one of the left-eye lens and the right-eye lens is within the predetermined range in the image in the vertical direction in a state that the lens cap is attached and the lens adjusting unit adjusts the lens positions of the left-eye lens and the right-eye lens in the vertical direction integrally,
(ii) determines that a shift amount in the vertical direction between the subject image formed by the left-eye lens on the imaging sensor and the subject image formed by the right-eye lens on the imaging sensor is smaller than a predetermined amount in a state that the lens cap is not attached and the lens adjusting unit adjusts the lens position of the other one of the left-eye lens and the light-eye lens independently.

6. The imaging apparatus according to claim 5, wherein the pattern for the lens position adjustment of the lens cap includes a line diagonally intersecting with a horizontal direction of the imaging apparatus in a state that the lens cap is attached to the 3D conversion lens.

7. An imaging apparatus configured to be attached to a 3D conversion lens including a lens adjusting unit operable to adjust a lens position of an optical system included in the attached 3D conversion lens, the imaging apparatus comprising:
a memory;
a display device; and
a controller coupled to the memory and the display device, the controller configured by instructions stored in the memory to:
store a captured image from the 3D conversion lens in a memory portion, the captured image including a left-eye image and a right-eye image;
display the captured image on the display device with one or more boundary lines overlaying the captured image;
determine that the left-eye image and the right-eye image are properly aligned with respect to the one or more boundary lines; and
display a message on the display device in accordance with the determination that the left-eye image and the right-eye image are properly aligned with respect to the one or more boundary lines.

8. The imaging apparatus of claim 7, wherein the one or more boundary lines overlaying the captured image include a boundary line for defining horizontal alignment of a left-eye lens and a right-eye lens included in the optical system of the 3D conversion lens.

9. The imaging apparatus of claim 7, wherein the one or more boundary lines overlaying the captured image include a boundary line for defining vertical alignment of a left-eye lens and a right-eye lens included in the optical system of the 3D conversion lens.

10. The imaging apparatus of claim 7, wherein the controller is further configured to:
store another captured image from the 3D conversion lens in the memory portion including a left-eye image and a right-eye image;
display the another captured image on the display unit with one of the left-eye image and the right-eye image overlapping the other of the left-eye image and the right-eye image;
determine that a shift amount between vertical positions of the left-eye image and the right-eye image are greater than a predetermined amount associated with proper vertical alignment of a left-eye lens and a right-eye lens included in the optical system of the 3D conversion lens; and
display a message on the display device in accordance with the determined shift amount.

11. The imaging apparatus of claim 7, wherein the 3D conversion lens to which the imaging apparatus is configured to be attached to is further configured to be attached to a lens cap, the lens cap provided with a pattern including a reference line substantially in parallel to a horizontal direction of the imaging apparatus when the 3D conversion lens is attached to the imaging apparatus, wherein the controller is further configured to:
determine that the left-eye image and the right-eye image are properly aligned with respect to the one or more boundary lines based upon a position of the reference line in one of the left-eye image and the right-eye image and the one or more boundary lines.
